(19) United States
(12) Patent Application Publication
(10) Pub. No.: US 2016/0065018 A1
(43) Pub. Date: Mar. 3, 2016

(54) ROTARY ELECTRICAL MACHINE HAVING PERMANENT MAGNET ROTOR

(71) Applicant: EBARA CORPORATION, Tokyo (JP)

(72) Inventors: Kazutaka YOSHIDA, Tokyo (JP); Tadashi KATAOKA, Tokyo (JP)

(21) Appl. No.: 14/837,435

(22) Filed: Aug. 27, 2015

(30) Foreign Application Priority Data
Sep. 1, 2014 (JP) 2014-177416

(51) Int. Cl. H02K 1/27

(52) U.S. Cl. CPC H02K 1/2786

(57) ABSTRACT

A rotary electrical machine capable of preventing an increase in a magnetic flux density at both ends of a rotor that can occur due to a leakage flux to thereby prevent a local overheat of the rotor is disclosed. The rotary electrical machine includes: a rotor having a rotor core and permanent magnets disposed on an outer surface of the rotor core; a stator having windings arranged around the rotor; and a shaft which is rotatable together with the rotor. The rotor core is a solid rotor core having a solid structure, the rotor core has protrusions at both sides of each of the permanent magnets, and annular recesses, extending in a circumferential direction of the rotor, are formed on outer surfaces of the protrusions, respectively.

### CROSS REFERENCE TO RELATED APPLICATION

This document claims priority to Japanese Patent Application Number 2014-177416 filed Sep. 1, 2014, the entire contents of which are hereby incorporated by reference.

### BACKGROUND

An SPM (Surface Permanent Magnet) rotor, which has permanent magnets arranged on a surface of a rotor core, has been known as a permanent magnet rotor used in a rotary electrical machine, such as an electric motor or an electric generator. FIG. 6 is a schematic view showing an example of the SPM rotor. The rotor 100 includes a rotor core 101 made of magnetic material, and a plurality of permanent magnets 104 arranged on an outer surface of the rotor core 101. A protective cover 105, which may be made of fiber-reinforced resin, is disposed outside of the permanent magnets 104, so that outer surfaces of the permanent magnets 104 are covered with the protective cover 105. This protective cover 105 serves to prevent the permanent magnets from coming off the rotor 100 when the rotor 100 is rotating at a high speed. The rotor core 101 is secured to a shaft 112 which is supported by bearings 112, and the rotor 100 and the shaft 112 rotate together.

The rotor core 101, made of magnetic material, has a function as magnetic paths of the permanent magnets 104, and also serves as a structure for supporting the permanent magnets 104. A stator 120 is disposed so as to surround the rotor 100, and the stator 120 is secured to a flame 126. The stator 120 includes a stator core 122 having a plurality of teeth 121, and a plurality of windings 124 which are attached to these teeth 121, respectively.

A high-speed electric motor or electric generator, whose rated speed is at least 10,000 min⁻¹, is required to have a high stiffness of the rotor 100 in its entirety. For this reason, the rotor core 101 has a solid structure, instead of a laminated structure of silicon steel sheets. Further, in order to enhance the stifthess of the rotor core 101 itself, the rotor core 101 has protrusions 101a on both sides of the permanent magnets 104.

However, the protrusions 101a are adjacent to ends 124a of the windings 124. As a result, leakage flux, which is generated around the ends 124a of the windings 124, increases as shown in FIG. 7. The leakage flux passes through the rotor core 101 that serves as the magnetic path, thus forming a magnetic path that leans toward a permanent-magnet side where a magnet potential is high. This magnetic path produces a high-magnetic-flux-density region at each axial end of the rotor 100 (see a graph in FIG. 7).

In an ideal synchronous motor, an amount of main magnetic flux does not fluctuate on a surface of the rotor 100, and a location of the magnetic flux which penetrates through the rotor 100 also does not vary, because the rotor 100 rotates so as to follow the main magnetic flux. Therefore, an eddy current is not generated in the rotor 100. However, in an actual synchronous motor, a magnetic resistance varies largely along an inner circumference of the stator core 122, and a clear sinusoidal magnetic-flux distribution is not formed, because a finite number of slots for housing the windings 124 therein are formed in the stator core 122, and the teeth 121 and the slots are arranged alternately.

FIG. 8 is a graph showing a rotating magnetic field generated by the stator 120 as an armature. In FIG. 8, a vertical axis represents magnetic flux density, and a horizontal axis represents electrical angle [rad]. As the magnetic field rotates, a magnetic flux component, which is pulsating in response to a fluctuation of the magnetic resistance of the stator core 122, is superimposed on a sinusoidal magnetic flux distribution. The permanent magnet 104 of the rotor 100 rotates so as to follow a magnetic pole of the stator 120. So long as a load is constant, a relative position between the magnetic pole of the stator 120 and the permanent magnet 104 does not vary, and an average of the magnetic flux on the surface of the rotor 100 also does not vary.

However, as shown in FIG. 8, since the magnetic flux, generated from the magnetic pole, contains the magnetic flux component that pulsates with time, a spiral electromotive force is generated in the permanent magnet 104 and the protrusion 101a due to the temporal change in the magnetic flux. As a result, an eddy current flows in the permanent magnet 104 and the protrusion 101a, thus generating heat. In particular, when the rotary electrical machine is rotating at high speed with a high drive frequency, an amount of change in the magnetic flux per unit time, i.e., an induced electromotive force [−dφ/dt], becomes larger, thus generating a remarkably large eddy current.

The heat generation due to the eddy current is proportional to the square of an eddy current density, and the eddy current density is proportional to the magnetic flux density. Accordingly, when the magnetic flux density is high at both sides of the permanent magnet 104 as shown in FIG. 7, the heat generation becomes prominent at both sides of the permanent magnet 104. As a result, a torque is lowered due to a thermal demagnetization of the permanent magnet 104. In addition, the protective cover 105, disposed at the outside of the permanent magnet 104, is locally overheated, possibly causing dangerous situations, such as a decrease in a capability of fixing the permanent magnet 104 due to a degradation of the protective cover 105, an occurrence of dynamic unbalance of the rotor 100 due to a heat dissipation of resin that forms the protective cover 105, and an occurrence of vibration due to the unbalance.

In recent years, there is a tendency to use, as the permanent magnet 104, a rare-earth magnet having a high magnetic flux density. Use of such permanent magnet can achieve significant size reduction and high output power, compared to an induction rotary electrical machine and a synchronous rotary electrical machine having field windings. However, downsizing of the rotary electrical machine entails a higher magnetic flux density of the stator core 122 and a smaller distance between the winding 124 and the magnetic material of the rotor 100, resulting in an increase in leakage flux at the ends 124a of the winding 124 and also resulting in an increase in the eddy current generated in the rotor 100 due to the leakage flux.

### SUMMARY OF THE INVENTION

According to an embodiment, there is provided a rotary electrical machine capable of preventing an increase in a magnetic flux density at both ends of a rotor that can occur due to a leakage flux to thereby prevent a local overheat of the rotor.

Embodiments, which will be described below, relate to a rotary electrical machine, such as an electric motor or an electric generator, having a permanent magnet rotor which rotates at a high speed, and more particularly to a rotor structure for preventing a local heat generation in the permanent magnet rotor.

In an embodiment, there is provided a rotary electrical machine comprising: a rotor having a rotor core and permanent magnets disposed on an outer surface of the rotor core; a stator having windings arranged around the rotor; and a shaft which is rotatable together with the rotor, wherein the rotor core is a solid rotor core having a solid structure, the rotor core has protrusions at both sides of each of the permanent magnets, and annular recesses, extending in a circumferential direction of the rotor, are formed on outer surfaces of the protrusions, respectively.

In an embodiment, there is provided a rotary electrical machine comprising: a rotor having a rotor core and permanent magnets disposed on an outer surface of the rotor core; a stator having windings arranged around the rotor; and a shaft which is rotatable together with the rotor, wherein the rotor core is a solid rotor core having a solid structure, the rotor core has protrusions at both sides of each of the permanent magnets, and an axial length of the rotor core is shorter than an axial length of the windings.

In an embodiment, there is provided a rotary electrical machine comprising: a rotor having a rotor core and permanent magnets disposed on an outer surface of the rotor core; a stator having windings arranged around the rotor; and a shaft which is rotatable together with the rotor, wherein the rotor core is a solid rotor core having a solid structure, the rotor core has protrusions at both sides of each of the permanent magnets, and non-magnetic rings are attached to outer surfaces of the protrusions, respectively.

In an embodiment, there is provided a rotary electrical machine comprising: a rotor having a rotor core and permanent magnets disposed on an outer surface of the rotor core; a stator having windings arranged around the rotor; and a shaft which is rotatable together with the rotor, wherein the rotor core is a solid rotor core having a solid structure, the rotor core has protrusions at both sides of each of the permanent magnets, and non-magnetic rings are disposed in annular grooves, respectively, which are formed on outer surfaces of the protrusions.

In an embodiment, there is provided a rotary electrical machine, comprising: a rotor having a rotor core and permanent magnets disposed on an outer surface of the rotor core; a stator having windings arranged around the rotor; and a shaft which is rotatable together with the rotor, wherein the rotor core is a solid rotor core having a solid structure, the rotor core has protrusions at both sides of each of the permanent magnets, and tapered surfaces, sloping toward both end portions of the permanent magnets, are formed on outer surfaces of the permanent magnets.

In an embodiment, the rotor core is integral with the shaft.

According to the above-described embodiments, a magnetic resistance between the windings and the rotor increases, thus reducing leakage flux passing through the rotor core and the permanent magnets. Therefore, a generation of eddy current due to a temporal change in the leakage flux can be reduced. As a result, even if the rotor rotates at a high speed, a local overheating of both ends of the rotor can be prevented.

### BRIEF DESCRIPTION OF THE DRAWINGS

FIG. 1 is a cross-sectional view showing a rotary electrical machine according to an embodiment;

FIG. 2 is a cross-sectional view showing a rotary electrical machine according to another embodiment;

FIG. 3 is a cross-sectional view showing a rotary electrical machine according to still another embodiment;

FIG. 4 is a cross-sectional view showing a rotary electrical machine according to still another embodiment;

FIG. 5 is a cross-sectional view showing a rotary electrical machine according to still another embodiment;

FIG. 6 is a schematic view showing an example of SPM rotor;

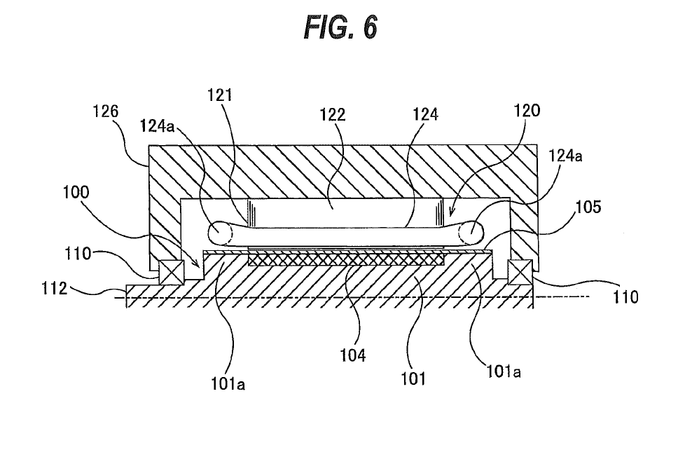

FIG. 7 is a schematic view showing leakage flux generated at ends of a winding; and

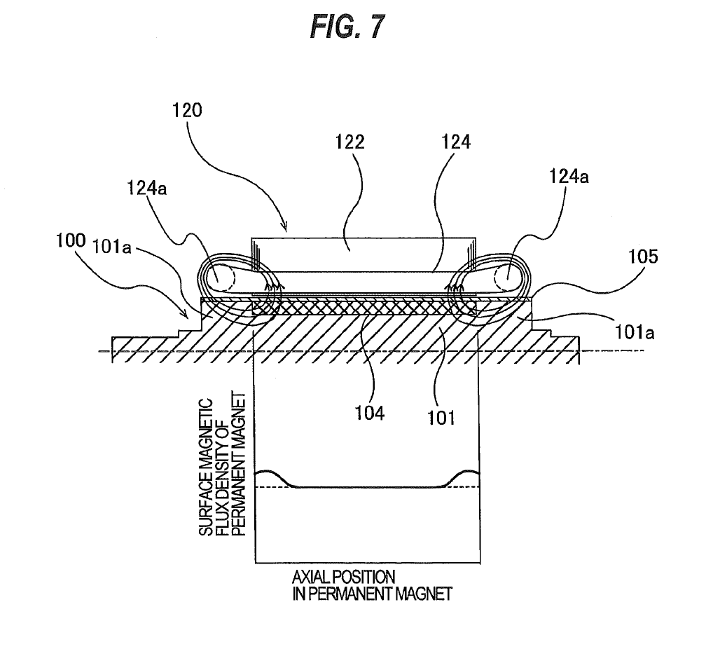

FIG. 8 is a graph showing a rotating magnetic field generated by a stator as an armature.

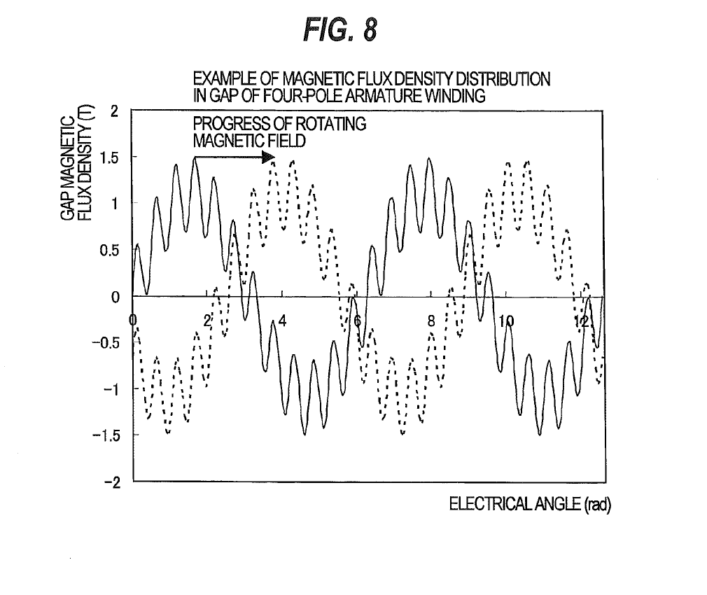

### DESCRIPTION OF EMBODIMENTS

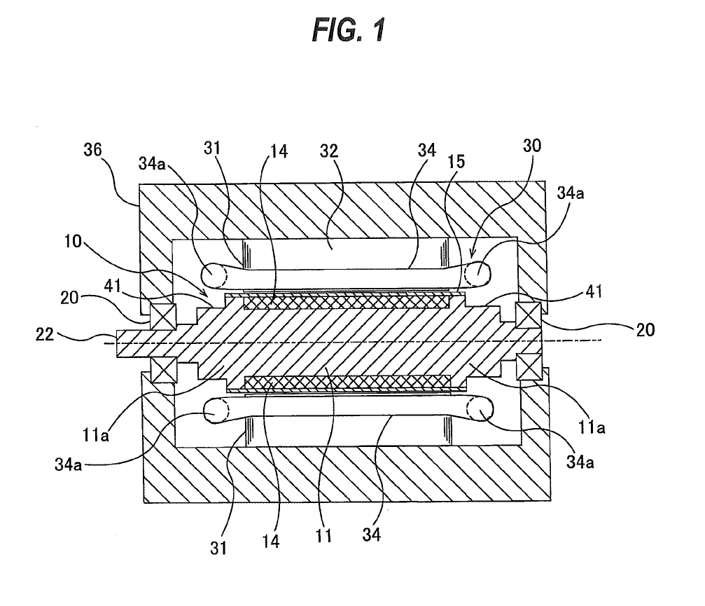

Embodiments will be described below with reference to the drawings. FIG. 1 is a cross-sectional view showing a SPM (Surface Permanent Magnet) rotary electrical machine according to an embodiment. In this specification, the rotary electrical machine is a general term for an electric motor and an electric generator. The rotary electrical machine according to the embodiment is a high-speed electric motor or electric generator whose rated speed is at least 10,000 min⁻¹.

As shown in FIG. 1, a rotor 10 includes a rotor core 11 made of a magnetic material, and a plurality of permanent magnets 14 arranged on an outer surface of the rotor core 11. A protective cover 15, which is made of a fiber-reinforced resin or the like, is disposed outside of the permanent magnets 104, so that outer surfaces of the permanent magnets 104 are covered with the protective cover 15. This protective cover 15 serves to prevent the permanent magnets 14 from coming off the rotor 10 when the rotor 10 is rotating at a high speed.

The rotor core 11 is secured to a shaft 22 which is supported by bearings 20. The rotor 10 and the shaft 22 rotate together. In order to enhance a stiffness of the rotor 10, the rotor core 11 may preferably be integral with the shaft 22. More specifically, both of the rotor core 11 and the shaft 22 may be integrally formed from the same magnetic material. The rotor core 11 serves as magnetic paths of the permanent magnets 14, and also serves as a structure for supporting the permanent magnets 104.

A stator 30 is disposed so as to surround the rotor 10, and the stator 30 is secured to a flame 36. The stator 30 includes a stator core 32 having a plurality of teeth 31, and a plurality of windings 34 which are attached to the teeth 121, respectively.

In order to enhance the stiffness of the rotor 10, the rotor core 11 has a solid structure. The rotor core 11 having such a structure is called a solid rotor core, which has a higher stiffness than that of a laminated structure which is typically used in a low-speed rotary electrical machine and is formed from multiple silicon steel sheets. This solid rotor core 11 can maintain its stable posture without generating vibrations, even when the rotor core 11 rotates at a high speed of several tens of thousands min⁻¹.

In order to enhance the stiffness of the rotor core 11 itself, the rotor core 11 has protrusions 11a at both sides of the permanent magnets 14. Therefore, an axial length of the entirety of the rotor core 11 is longer than an axial length of the windings 34. Both ends of each permanent magnet 14 are supported by the protrusions 11a. Outer surfaces of the protrusions 11a and the permanent magnets 14 are covered with the protective cover 15.

In this embodiment, in order to suppress a leakage flux at ends 34a of each winding 34 and to suppress eddy current in the protrusions 11a and the permanent magnets 14, annular recesses 41, each extending in a circumferential direction of the rotor 10, are formed on outer surfaces of the protrusions 11a, respectively, to form small-diameter portions of the rotor 10. These annular recesses 41 are located inwardly of the ends 34a of each winding 34 with respect to a radial direction of the stator 30.

Each annular recess 41 serves to increase a gap between the end 34a of the winding 34 and the protrusion 11a of the rotor core 11, so that a magnetic resistance between the end 34a of the winding 34 and the rotor core 11 can be increased, thus preventing formation of the magnetic paths in the both end of the rotor 10 and reducing the leakage flux. As a result, a local overheating of the permanent magnets 14 and the rotor core 11 due to the eddy current can be prevented.

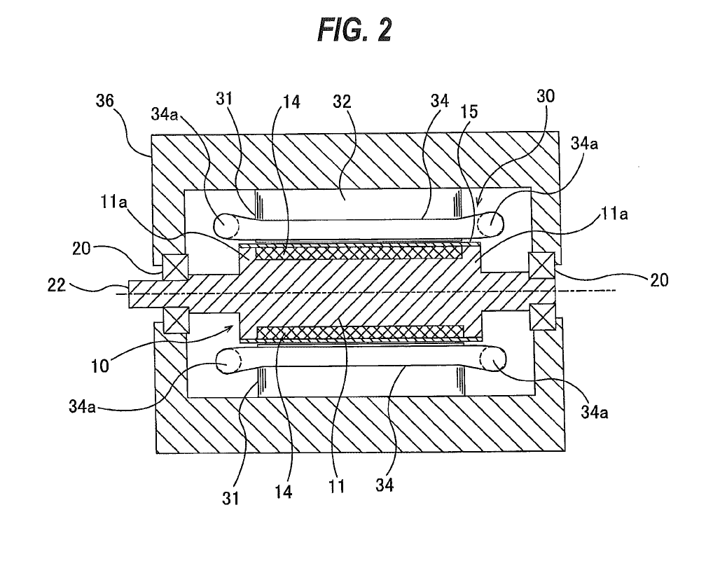

FIG. 2 is a cross-sectional view showing a SPM rotary electrical machine according to another embodiment. Structures of this embodiment, which will not be described particularly, are identical to those of the embodiment shown in FIG. 1, and their repetitive descriptions will be omitted.

As shown in FIG. 2, this embodiment is the same as the embodiment shown in FIG. 1 in that the rotor core 11 has the protrusions 11a for enhancing the stiffness of the rotor core 11, but is different in that the axial length of each protrusion 11a is shorter than the axial length of each protrusion 11a shown in FIG. 1, and that the axial length of the rotor core 11 is shorter than the axial length of each winding 34. More specifically, the protrusions 11a of the rotor core 11 are located inwardly of the ends 34a of each winding 34 with respect to the axial direction.

According to this embodiment, the rotor core 11 does not exist radially inwardly of the ends 34a of the winding 34. Therefore, a gap between the end 34a of the winding 34 and the end of the rotor core 11 is increased, so that the magnetic resistance between the end 34a of the winding 34 and the rotor core 11 can be increased, thus preventing formation of the magnetic paths in the both end of the rotor 10 and reducing the leakage flux. As a result, a local overheating of the permanent magnets 14 and the rotor core 11 due to the eddy current can be prevented.

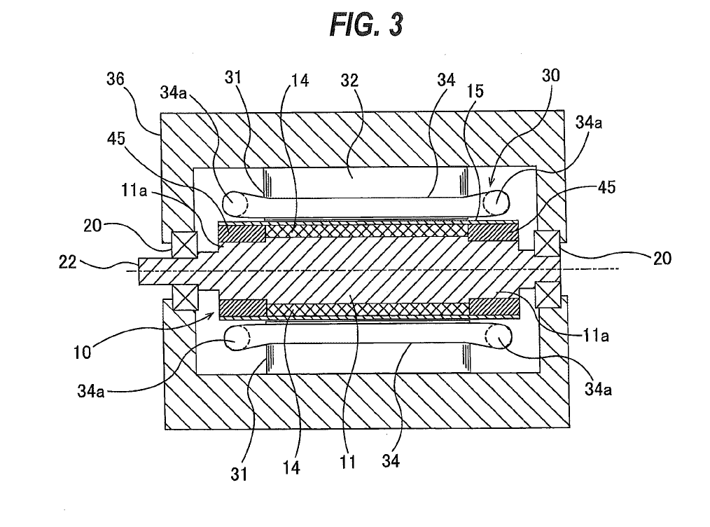

FIG. 3 is a cross-sectional view showing a SPM type rotary electrical machine according to sill another embodiment. Structures of this embodiment, which will not be described particularly, are identical to those of the embodiment shown in FIG. 1, and their repetitive descriptions will be omitted.

As shown in FIG. 3, this embodiment is the same as the embodiment shown in FIG. 1 in that the rotor core 11 has the protrusions 11a for enhancing the stiffness of the rotor core 11, but is different in that the outer diameter of each protrusion 11a is smaller than that of the embodiment shown in FIG. 1, and that non-magnetic rings 45 are attached to outer surfaces of the protrusions 11a, respectively. Both end portions of each permanent magnet 14 are supported by the non-magnetic rings 45, respectively. The non-magnetic rings 45 are located inwardly of the ends 34a of each winding 34 with respect to the radial direction of the stator 30. The non-magnetic rings 45 are made of non-magnetic rigid material, e.g., non-magnetic stainless steel. The reason for using the rigid material for the non-magnetic rings 45 is to enhance the stiffness of the rotor core 11. Outer surfaces of the non-magnetic rings 45 and the permanent magnets 14 are covered with the protective cover 15.

The non-magnetic rings 45 can increase the magnetic resistance between the ends 34a of the windings 34 and the rotor core 11. Therefore, the formation of the magnetic paths in the both ends of the rotor 10 can be prevented, and the leakage flux can be reduced. As a result, the local overheating of the permanent magnets 14 and the rotor core 11 due to eddy current can be prevented. The non-magnetic rings 45 can be mounted to the protrusions 11a of the rotor core 11 by shrink-fitting or press-fitting. The embodiment shown in FIG. 3 can increase the stiffness of the rotor 10 as compared with the embodiments shown in FIGS. 1 and 2.

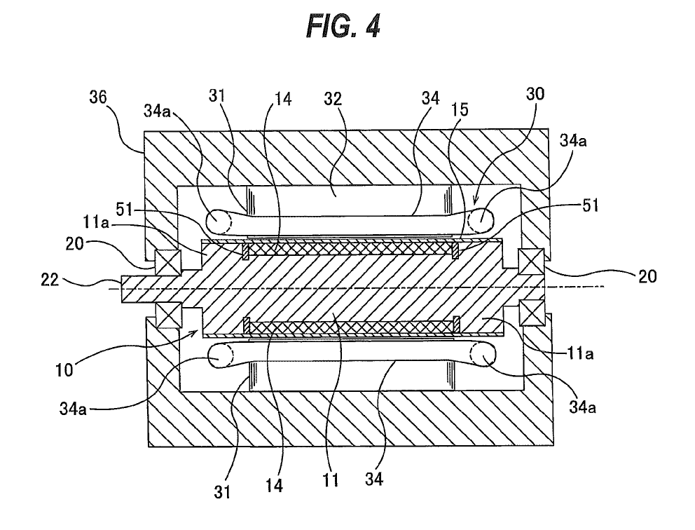

FIG. 4 is a cross-sectional view showing a SPM type rotary electrical machine according to still another embodiment. Structures of this embodiment, which will not be described particularly, are identical to those of the embodiment shown in FIG. 1, and their repetitive descriptions will be omitted.

As shown in FIG. 4, this embodiment is the same as the embodiment shown in FIG. 1 in that the rotor core 11 has the protrusions 11a in order to enhance the stiffness of the rotor core 11, but is different in that annular grooves extending in a circumferential direction of the rotor 10 are formed on outer surfaces of the protrusions 11a, respectively, and non-magnetic rings 51 are housed in these annular grooves, respectively. The non-magnetic rings 51 are located on both sides of each permanent magnet 14, so that both end portions of each permanent magnet 14 are supported by the non-magnetic rings 51. The outer surfaces of the protrusions 11a, the non-magnetic rings 51, and the permanent magnets 14 are covered with the protective cover 15. Each non-magnetic ring 51 is constructed by a plurality of segments so that the non-magnetic ring 51 is able to be inserted into the annular groove from its outside.

Each non-magnetic ring 51 is made of non-magnetic stainless steel, or non-magnetic and non-conducting ceramic. The non-magnetic rings 51 cover the both end portions of each permanent magnet 14 so as to interrupt the magnetic paths in the rotor core 11. As shown in FIG. 4, a radial width of the non-magnetic ring 51 is preferably larger than a radial width of the permanent magnet 14.

The non-magnetic rings 51 can increase the magnetic resistance between the ends 34a of the windings 34 and the permanent magnets 14. Therefore, the formation of the magnetic paths in the both ends of the rotor 10 can be prevented, and the leakage flux can be reduced. As a result, the local overheating of the permanent magnets 14 and the rotor core 11 due to eddy current can be prevented. The embodiment shown in FIG. 4 can increase the stiffness of the rotor 10 as compared with the embodiments shown in FIGS. 1 and 2.

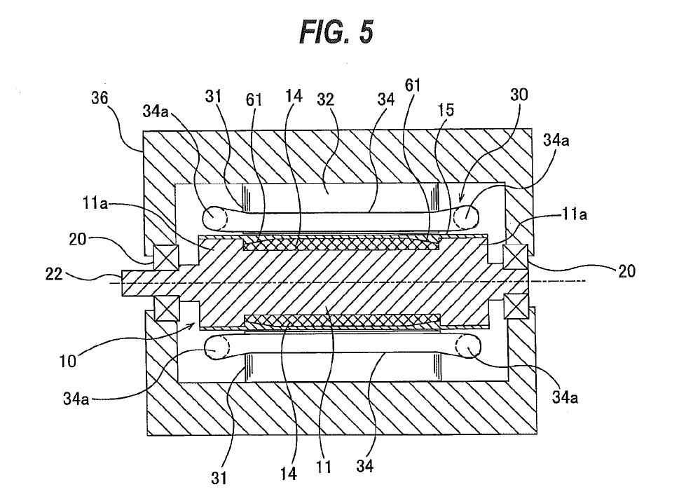

FIG. 5 is a cross-sectional view showing a SPM type rotary electrical machine according to still another embodiment. Structures of this embodiment, which will not be described particularly, are identical to those of the embodiment shown in FIG. 1, and their repetitive descriptions will be omitted.

As shown in FIG. 5, this embodiment is the same as the embodiment shown in FIG. 1 in that the rotor core 11 has the protrusions 11a for enhancing the stiffness of the rotor core 11, but is different in that the outer surface of each permanent magnet 14 has tapered surfaces 61 sloping toward the both end portions of the permanent magnet 14. More specifically, the both end portions of the permanent magnets 14 have a truncated-cone shape.

The tapered surface 61 of the permanent magnet 14 can increase the gap between the end 34a of the winding 34 and the permanent magnet 14, so that the magnetic resistance between the end 34a of the winding 34 and the permanent magnet 14 can be increased, thus reducing the leakage flux. As a result, the local overheating of the permanent magnets 14 and the rotor core 11 due to eddy current can be prevented.

While the embodiments of the present invention have been described above, it should be understood that the present invention is not intended to be limited to the above embodiments, and various changes and modifications may be made to the embodiments without departing from the scope of the appended claims.

What is claimed is:

1. A rotary electrical machine comprising:
a rotor having a rotor core and permanent magnets disposed on an outer surface of the rotor core;
a stator having windings arranged around the rotor; and
a shaft which is rotatable together with the rotor,
wherein the rotor core is a solid rotor core having a solid structure,
the rotor core has protrusions at both sides of each of the permanent magnets, and
annular recesses, extending in a circumferential direction of the rotor, are formed on outer surfaces of the protrusions, respectively.

2. The rotary electrical machine according to claim 1, wherein the rotor core is integral with the shaft.

3. A rotary electrical machine comprising:
a rotor having a rotor core and permanent magnets disposed on an outer surface of the rotor core;
a stator having windings arranged around the rotor; and
a shaft which is rotatable together with the rotor,
wherein the rotor core is a solid rotor core having a solid structure,
the rotor core has protrusions at both sides of each of the permanent magnets, and
an axial length of the rotor core is shorter than an axial length of the windings.

4. The rotary electrical machine according to claim 3, wherein the rotor core is integral with the shaft.

5. A rotary electrical machine comprising:
a rotor having a rotor core and permanent magnets disposed on an outer surface of the rotor core;
a stator having windings arranged around the rotor; and
a shaft which is rotatable together with the rotor,
wherein the rotor core is a solid rotor core having a solid structure,
the rotor core has protrusions at both sides of each of the permanent magnets, and
non-magnetic rings are attached to outer surfaces of the protrusions, respectively.

6. The rotary electrical machine according to claim 5, wherein the rotor core is integral with the shaft.

7. A rotary electrical machine comprising:
a rotor having a rotor core and permanent magnets disposed on an outer surface of the rotor core;
a stator having windings arranged around the rotor; and
a shaft which is rotatable together with the rotor,
wherein the rotor core is a solid rotor core having a solid structure,
the rotor core has protrusions at both sides of each of the permanent magnets, and
non-magnetic rings are disposed in annular grooves, respectively, which are formed on outer surfaces of the protrusions.

8. The rotary electrical machine according to claim 7, wherein the rotor core is integral with the shaft.

9. A rotary electrical machine, comprising:
a rotor having a rotor core and permanent magnets disposed on an outer surface of the rotor core;
a stator having windings arranged around the rotor; and
a shaft which is rotatable together with the rotor,
wherein the rotor core is a solid rotor core having a solid structure,
the rotor core has protrusions at both sides of each of the permanent magnets, and
tapered surfaces, sloping toward both end portions of the permanent magnets, are formed on outer surfaces of the permanent magnets.

10. The rotary electrical machine according to claim 9, wherein the rotor core is integral with the shaft.
